(19) United States
(12) Patent Application Publication
(10) Pub. No.: US 2012/0152184 A1
(43) Pub. Date: Jun. 21, 2012

(54) ENGINE WITH COMBINED COMBUSTION AND STEAM OPERATION FOR CURRENT GENERATION

(76) Inventor: Harald Lueck, Palma de Mallorca (ES)

(21) Appl. No.: 13/314,038

(22) Filed: Dec. 7, 2011

(30) Foreign Application Priority Data
Dec. 15, 2010 (CH) 2092/10

(51) Int. Cl. F02B 43/10; F02B 47/02

(52) U.S. Cl. 123/3; 123/25 P

(57) ABSTRACT

The inventive subject matter relates to an engine with combined combustion and steam operation, the engine comprising more than one cylinder in which in each case a piston is mounted, the pistons being coupled to a common crankshaft in the engine, at least one of the pistons being drivable by the combustion of a fuel mixture in the cylinder space, and at least one further piston being drivable by the introduction and expansion of steam in the cylinder space, the steam being generated in a steam generation device outside the cylinder space, and the steam generation device being operable at least partially by waste heat from the engine.

### RELATED APPLICATIONS

This application claims the benefit of and priority to Switzerland Patent Application Number 2092/10, filed Dec. 15, 2010, the contents of which are hereby incorporated by reference as if recited in full herein for all purposes.

### BACKGROUND

The inventive subject matter relates to an engine with waste heat utilization which is operated simultaneously by the introduction of steam and by combustion in cylinder spaces. In particular, the engine is intended for current generation.

In conventional internal combustion engines, the waste heat generated as a result of engine cooling and by the exhaust gases is often left unused. For internal combustion engines operating in a stationary manner, such as are used, for example, for current generation, the waste heat is utilized partially for feeding into a district heating network. However, utilizing the waste heat in this way presupposes that the location of the engine is selected such that it is possible for the feed into a district heating network to take place over short distances. Furthermore, the overall energy balance of such power plants with combined heat and power is unsatisfactory because of the high losses in the district heating lines.

The object on which the present inventive subject matter is based is to provide a more efficient utilization of waste heat generated by an internal combustion engine, such utilization being possible, in particular, even independently of location.

For this purpose, the inventive subject matter provides an engine with combined combustion and steam operation, the engine comprising more than one cylinder, in which in each case a piston is mounted, the pistons being coupled to a common crankshaft of the engine, at least one of the pistons being drivable by combustion in the cylinder space, and at least one further piston being drivable by the introduction and expansion of steam in the cylinder space, the steam being generated in a steam generation device outside the cylinder space, and the steam generation device being operable at least partially by waste heat from the engine.

The inventive subject matter accordingly makes use of the fact that the waste heat from the internal combustion engine is likewise converted, by means of a steam generation device and a special configuration of at least some of the cylinders in the engine which are drivable by steam expansion, into mechanical work which is subsequently available for conversion into electricity by means of a following generator. This type of conversion of waste heat into electricity makes it possible to utilize the waste heat, for example, for motors operating in a stationary manner in a power plant, without the waste heat merely being discharged into the environment or being employed under low efficiency for building heating.

### SUMMARY

According to a preferred embodiment, the waste heat of the engine from exhaust gases and/or from liquid cooling of the cylinders operating in a combustion mode is conducted into a heat exchanger of the steam generation device. As a rule, the waste heat would not be sufficient alone to ensure steam generation. The steam generation device may also have a burner which is operable by other fuels, as described further below. However, by the waste heat of the engine being utilized, the overall energy balance of the steam generation device is improved considerably.

According to a preferred embodiment, the one or more pistons which are drivable by combustion in the cylinder space is or are operable by means of the combustion of a gas mixture generated by the gasification of biomass. In particular, the gasification of plant parts is preferred, such as, for example, wood waste, wood chips, straw or other fast-growing grasses or reeds or cereals or molasses. Other waste may also be reutilized. For example, a gas mixture suitable for combustion operation may be generated from animal dung or from dried clarifying sludge, if appropriate by means of preceding drying and pelletizing.

According to a preferred embodiment, the one or more pistons which are drivable by combustion in the cylinder space is or are operable, furthermore, by liquid fuel, such as, in particular, vegetable oils or alcohols obtained from biomass. Furthermore, some of the cylinders operating in combustion mode may also be driven by biogas.

According to a preferred embodiment, a plurality of the cylinders of the engine have valve controls independent of one another. In particular, electrical valve controls are preferred. The advantage of these embodiments is that the cylinders can be set for the different fuels. Depending on the combustion behaviour of the respective fuel or ignitable gas mixture, the efficiency of the respective cylinders can be optimized by means of the valve control and optionally also by means of adjustable ignition.

Furthermore, according to a preferred embodiment, by virtue of the independent valve control and by changing over the supply line to the respective cylinder spaces, the cylinders can operate alternatively in combustion mode, that is to say, for example, by means of vegetable oil or alcohol or gases obtained by the gasification of biomass, and steam operation. The advantage of this embodiment is that, depending on the available waste heat from the engine, more or fewer cylinders can be operable in steam mode or can be operable by means of one of the alternative fuels. Furthermore, it is also advantageous to change over the cylinders from combustion to steam operation in order to clean cylinders, which may have fuel deposits by steam operation.

In a preferred embodiment, the engine is coupled to a generator for current generation. In particular generators for generating alternating current are provided, which are set up for feeding current into the network. Preferably, frequency stabilization in the combination of engine and generator is provided for generating an alternating current having the frequency necessary for the network. Frequency stabilization may be achieved, for example, by changing over the available fuels and the number of cylinders that operate in steam mode. In particular, short-term changes in the power ratio of the engine are possible by means of liquid fuels or biogas because these fuels can be metered effectively. The combustible gas mixtures generated by the gasification of biomass cannot be metered so simply because of the inertia of the gasification device. Furthermore, the available steam quantity also cannot be regulated for a short time by means of the steam generation device. Constant engine operation is therefore advantageously regulated by means of the cylinders, which are operable with liquid fuels. If appropriate, the use of conventional fossil fuels, such as diesel fuel, in addition to the above-mentioned fuels may also be provided.

According to a preferred embodiment, part of the waste heat from the engine and/or unused residual heat from the steam generation device may be supplied to a device for the drying of biomass. Since lower temperatures are necessary for drying the biomass than for the steam generation device, the waste heat from the engine can be utilized especially efficiently. First, the hot exhaust gases and/or the coolant that cools an engine arrive at the steam generation device. After flowing through the heat exchanger, they are cooled to a lower temperature. However, this lower temperature can also be used in a subsequent step for drying the biomass, which can then be supplied to a gasification device.

According to a preferred embodiment, the steam generation device is operable not only by the waste heat from the engine, but also as a result of the combustion of gas generated from biomass, vegetable oil and/or alcohol generated from biomass. As a result of this conventional combustion, the necessary temperatures required for steam generation are achieved. The heat exchanger, which is operable with the waste heat from the engine, may be used, for example, as a preliminary stage for preheating the liquid phase from which the steam is generated. Water is in this case preferred.

According to a preferred embodiment, furthermore, the engine is coupled to a device for the gasification of biomass and waste heat from the gasification device is used for operating the steam generation device. Gasifying the biomass gives rise to gas at high temperatures, which must be cooled, in order to be introduced into the engine. This takes place in a gas cooler. The waste heat that occurs in the gas cooler may be utilized in a preliminary stage for the steam generation device.

These and other embodiments are described in more detail in the following detailed descriptions and the figures. The foregoing is not intended to be an exhaustive list of embodiments and features of the inventive subject matter. Persons skilled in the art are capable of appreciating other embodiments and features from the following detailed description in conjunction with the drawings.

### BRIEF DESCRIPTION OF THE DRAWINGS

The following figures show embodiments according to the inventive subject matter.

FIG. 1 shows a block diagram of the complete system consisting of an engine and of the components connected for operation in the engine.

FIG. 2 shows a diagrammatic flowchart of a cylinder of the engine in combustion operation and in steam operation.

### DETAILED DESCRIPTION

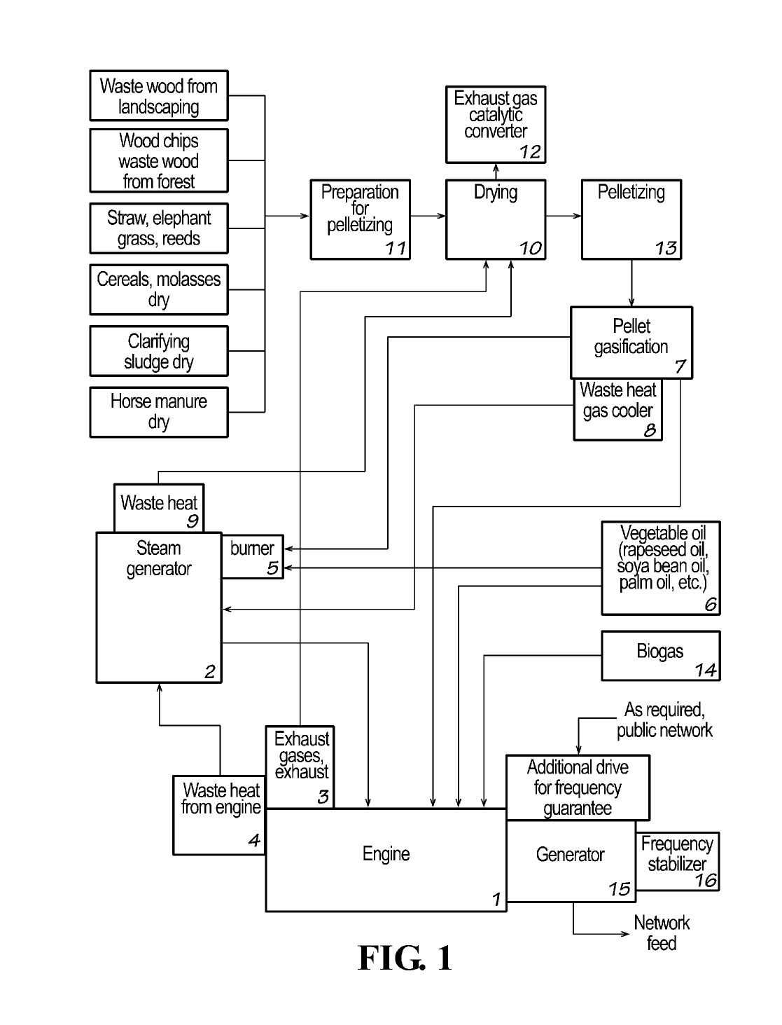

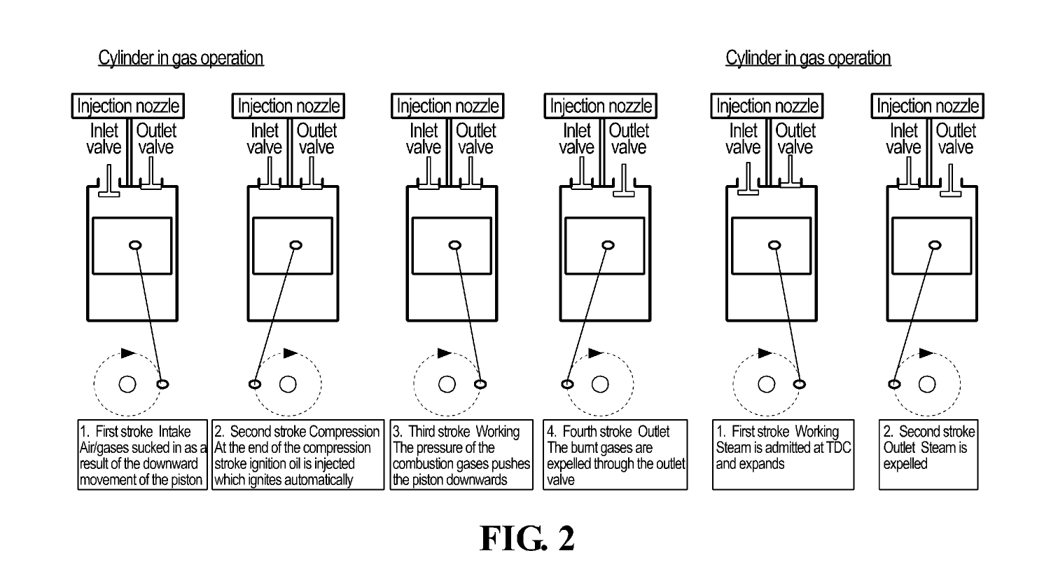

Representative embodiments according to the inventive subject matter are shown in FIGS. 1 and 2 wherein the same or generally similar features share common reference numerals.

The core of the plant for the current generation is an engine in the form of the engine 1. The engine 1 is set up to be operable variably with conventional fuels such as vegetable oil (rapeseed oil, soybean oil, palm oil, etc.), biogas and/or a gas mixture obtained from biomass. Furthermore, the engine is fed with steam from a steam generator 2. The engine 1 comprises a plurality of cylinders that act upon a common crankshaft. The cylinders can operate alternatively with a fuel mixture in combustion mode or with steam in steam mode. For this purpose, the engine comprises a variable valve control, which can be adapted to the respective fuel mixture. In combustion mode, the respective cylinder, one of which is illustrated by way of example in FIG. 2, operates on the four-stroke principle. Furthermore, the supply line to the valves can also be changed over to steam. The valve control of the cylinders which are operable with steam is varied. Steam is introduced through the inlet valves of the cylinder and, in the working stroke, drives the piston as a result of expansion of the steam (see the first stroke in steam operation in FIG. 2). After the expansion of the steam, this is discharged again through the outlet valves (see the second stroke in steam operation in FIG. 2). In steam operation, therefore, every second stroke is a working stroke in which the piston is driven. During each stroke, therefore, the inlet and outlet valves are opened and closed again, in contrast to combustion operation. Furthermore, a special feature of the engine 1 is that a plurality of, preferably all the cylinders of the engine can be changed over individually from the operating mode with steam to combustion operation with various fuels of those mentioned. This is possible due to the electrical valve control, that is to say without any mechanical coupling of the valve to the crankshaft. The electrical valve control makes it possible to change over the inlet and outlet valves from the four-stroke principle in combustion operation to the two-stroke principle in steam operation. Furthermore, the valve control can be set to the various fuels in combustion operation.

The waste heat of the engine 1 is obtained from exhaust gases of the engine, that is to say of the cylinders that operate in combustion mode. For this purpose, a corresponding heat exchanger for exhaust gases from the exhaust 3 is provided. Furthermore, the waste heat of the engine can also be obtained from a cooling circuit of the engine, for example a liquid cooling circuit. The waste heat from the engine is delivered via a heat exchanger 4 to the steam generator 2. The steam generator, which operates essentially in the manner of a conventional boiler, is operable not only by the waste heat from the engine via the heat exchanger 4, but also by a burner 5. The burner 5 can burn vegetable oil (rapeseed oil, soybean oil, palm oil, etc.) 6 and/or an ignitable gas mixture obtained from pellet gasification. Furthermore, waste heat necessarily occurs in a device for pellet gasification 7 which is described further below. This waste heat may likewise be utilized by a waste heat gas cooler 8 in order to be supplied, as a preliminary stage of steam generation, to the steam generation unit 2.

During steam generation in the steam generator 2, the medium that transports the waste heat from the engine 1 via the heat exchanger 4 to the steam generator 2 is cooled to a lower temperature that can no longer be used for steam generation. However, this waste heat 9 can still be supplied to a drying unit 10 which is intended for drying biomass for subsequent pellet production.

The biomass may comprise waste wood, for example from landscaping, or wood chips from the forest. Furthermore, straw and fast-growing grasses, such as elephant grass or reeds, and also cereals and molasses are preferred. Dried clarifying sludge or animal dung may also be used for pellet processing. These materials are supplied to the drying unit 10 after appropriate comminution in a preparatory device for pelletizing 11. The exhaust gases from the drying unit 10 are supplied to an exhaust gas catalytic converter 12. After the residual moisture of the biomass has been reduced in the drying unit 10, the biomass is delivered for a pressing process in a pelletizing device 13. After the pellets have been formed in the device 13, they are conveyed into the pellet gasification device 7. In the pellet gasification device, the pellets are converted into an ignitable gas mixture in the manner of wood gasification. The gas mixture first has to be cooled before it is introduced into the engine 1. The waste heat that occurs in this case is transferred via the gas cooler 8 to the steam generation unit 2, as described above.

It becomes clear from the above description that the waste heat of the engine 1 can be used in stages first in the steam generation unit 2 and later also for drying the drying unit 10. As a result, the required quantity of fuels to be burnt, such as the vegetable oil 6, biogas 14 or, if appropriate, fossil fuels (not illustrated in the figure), is reduced.

Connected to the engine 1 is the generator 15 which is set up for current generation and for feeding the current into the network. An additional frequency stabilizer 16 which can influence the engine management of the engine 1 in order to keep the rotation speed stable is provided so as to make it possible to generate alternating current at the necessary network frequency. Furthermore, an additional drive 17, for example in the form of an electric motor, is also provided in order to maintain the necessary rotational speed for operating the generator 16 if the power of the engine 1 is temporarily insufficient, for example because of change-over of the engine to combustion or steam operation or a warm-up phase of the steam generation device 2 or pellet gasification device 7. Alternatively, a multi-stage generator may also be provided, which first generates direct current and, via a direct-current motor, drives an oscillating-current generator with constant frequency.

Numerous changes can be made to the embodiments described above, without deviating from the scope of the inventive subject matter, such as is presented in the claims. In particular, fuels other than those mentioned may also be provided. For example, a fossil fuel may also be used preferably for starting the system, operation with the alternatively obtained fuels being preferred for subsequent continuous operation.

Persons skilled in the art will recognize that many modifications and variations are possible in the details, materials, and arrangements of the parts and actions which have been described and illustrated in order to explain the nature of the inventive subject matter, and that such modifications and variations do not depart from the spirit and scope of the teachings and claims contained therein.

All patent and non-patent literature cited herein is hereby incorporated by references in its entirety for all purposes.

1. An engine with combined combustion and steam operation, the engine comprising more than one cylinder in which in each case a piston is mounted, the pistons being coupled to a common crankshaft in the engine characterized in that at least one of the pistons is drivable by the combustion of a fuel mixture in the cylinder space, and at least one further piston is drivable by the introduction and expansion of steam in the cylinder space, the steam being generated in a steam generation device outside the cylinder space, and the steam generation device being operable at least partially by waste heat from the engine.

2. The engine according to claim 1, wherein the waste heat of the engine from exhaust gases and/or from liquid cooling of the cylinders operating in combustion mode being conducted to a heat exchanger of the steam generation device.

3. The engine according to claim 1, wherein the one or more pistons are drivable by combustion in the cylinder space by means of the combustion of a gas mixture generated by the gasification of biomass.

4. The engine according to claim 1, wherein the one or more pistons that are drivable by combustion in the cylinder space being operable by a liquid fuel.

5. The engine according to claim 1, wherein a plurality of the cylinders of the engine have valve controls independent of one another.

6. The engine according to claim 5, wherein the plurality of cylinders being drivable variably, in combustion operation or in steam operation, in dependence on a setting of the valve control and of the supply lines for steam or a fuel mixture into the respective cylinder spaces.

7. The engine according to claim 1, further comprising a generator coupled to the engine for current generation.

8. The engine according claim 1, further comprising a device for drying biomass coupled to the engine, the device configured to dry the biomass using waste heat from the engine and/or unused residual heat from the steam generation device.

9. The engine according to claim 1, wherein the steam generation device being operable not only by the waste heat from the engine, but also by the combustion of gas generated from combustion of a fuel comprising a biomass or liquid biofuel.

10. The engine according to claim 1, further comprising a device coupled to the engine, the device being configured for the gasification of biomass, and for the transfer of waste heat from the gasification device to the steam generation device being operable using the waste heat.

11. The engine according to claim 5, wherein the valve controls comprise electrical valve controls.

12. The engine according to claim 4, wherein the liquid fuel comprises vegetable oil and/or an alcohol.
